(19) United States
(12) Patent Application Publication
(10) Pub. No.: US 2005/0120274 A1
(43) Pub. Date: Jun. 2, 2005

(54) Methods and apparatus to minimize debugging and testing time of applications

(76) Inventors: Mohammad R. Haghighat, San Jose, CA (US); David C. Sehr, Cupertino, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/714,033

(22) Filed: Nov. 14, 2003

(51) Int. Cl. G06F 11/00

(52) U.S. Cl. 714/38

(57) ABSTRACT

Methods and apparatus to minimize debugging and testing time of applications are described herein. In an example method, an instrumented code of the application is generated. A plurality of tests is executed on the instrumented code of the application. One or more test profiles associated with the plurality of tests are generated. A list containing at least one of the plurality of tests based on the one or more test profiles is identified.

### TECHNICAL FIELD

The present disclosure relates generally to software debugging and testing, and more particularly, to methods and apparatus to minimize debugging and testing time of applications.

### BACKGROUND

A significant amount of time and/or man power is spent on debugging and testing for defects in applications. Typically, a debugging process is built into the development, testing, and validation of an application to isolate errors in the application. In particular, the debugging program may include a number of tests to determine a starting breakpoint to identify an error (i.e., a “bug”). However, it may not be known which one of the tests that reaches the starting breakpoint faster than the other tests. As a result, a significant amount of time and/or man-power, especially in the case of long-running applications, may be required to identify those tests that minimize the amount of application debugging and testing time.

### BRIEF DESCRIPTION OF THE DRAWINGS

FIG. 1 is a block diagram representation of an example application debugging and testing time minimizing system constructed in accordance with the teachings the invention.

FIG. 2 is a block diagram representation of output data of the example system shown in FIG. 1.

FIG. 3 is a flow diagram representation of one manner in which the example system of FIG. 1 may be configured to minimize debugging and testing time of applications.

FIG. 4 is a code representation of an example probe that may be used to implement the example system shown in FIG. 1.

FIG. 5 is a code representation of an example data analyzing device that may be used to implement the example system shown in FIG. 1.

FIG. 6 is a block diagram representation of an example processor system that may be used to implement the example system shown in FIG. 1.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

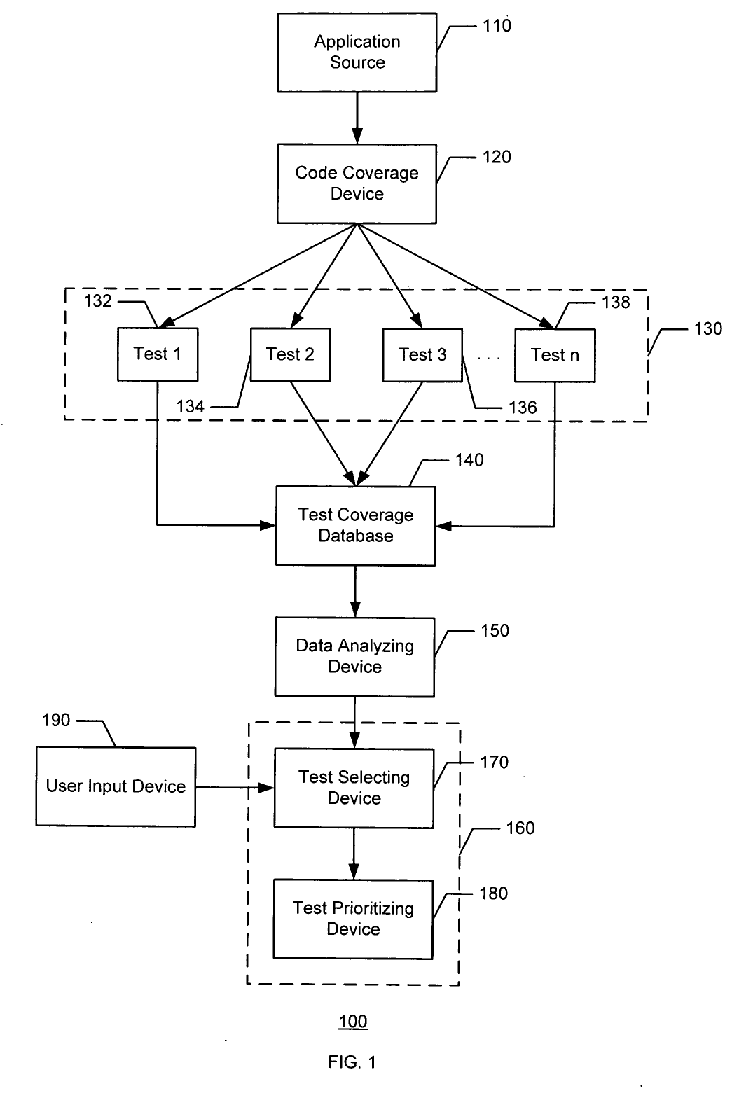

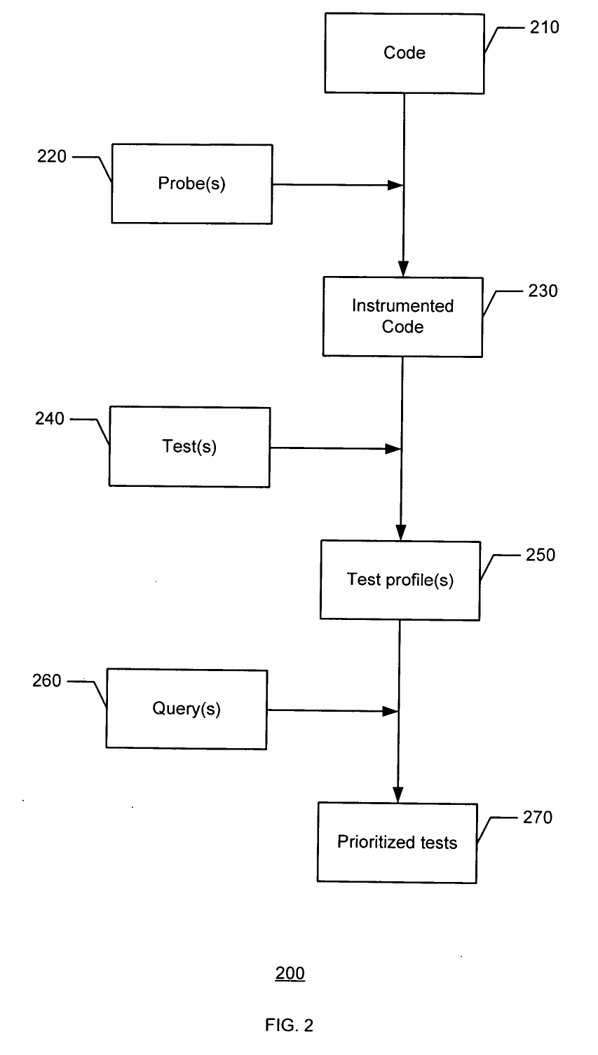

In the examples of FIGS. 1 and 2, the illustrated application debugging and testing time minimizing system 100 includes an application source 110, a code coverage device 120, a debugging and testing device 130, a test coverage database 140, a data analyzing device 150, and a test identifying device 160. In general, an instrumented code of an application is generated and a plurality of tests is executed on the instrumented code of the application. One or more test profiles associated with the plurality of tests are generated. Further, at least one of the plurality of tests is identified (i.e., selected and prioritized) based on the test profiles to minimize debugging and testing time of the application.

The application source 110 provides the code of an application 210 to the code coverage device 120. As used herein the term “application” refers to one or more methods, functions, routines, or subroutines for manipulating data. Persons of ordinary skill in the art will readily recognize that the code coverage device 120 is configured to identify portions of a particular application that did not execute during runtime of that application. Accordingly, the code coverage device 120 is configured to insert one or more probes 220 into the code of the application 210. For example, the probes 220 may be inserted at entries of a basic block into the code of the application 210. Each of the probes 220 is configured to identify one or more program states of interest to a user (e.g., a software developer or a programmer). For example, program states of interest may include a particular logical state (e.g., x=y, a true condition, etc.). The code coverage device 120 may be a compiler, an assembler, an interpreter, a post-link optimizer, a just-in-time (JIT) compiler, and/or any suitable mechanism to instrument the code of the application 210 (i.e., to insert one or more probes 220 into the code of the application 210).

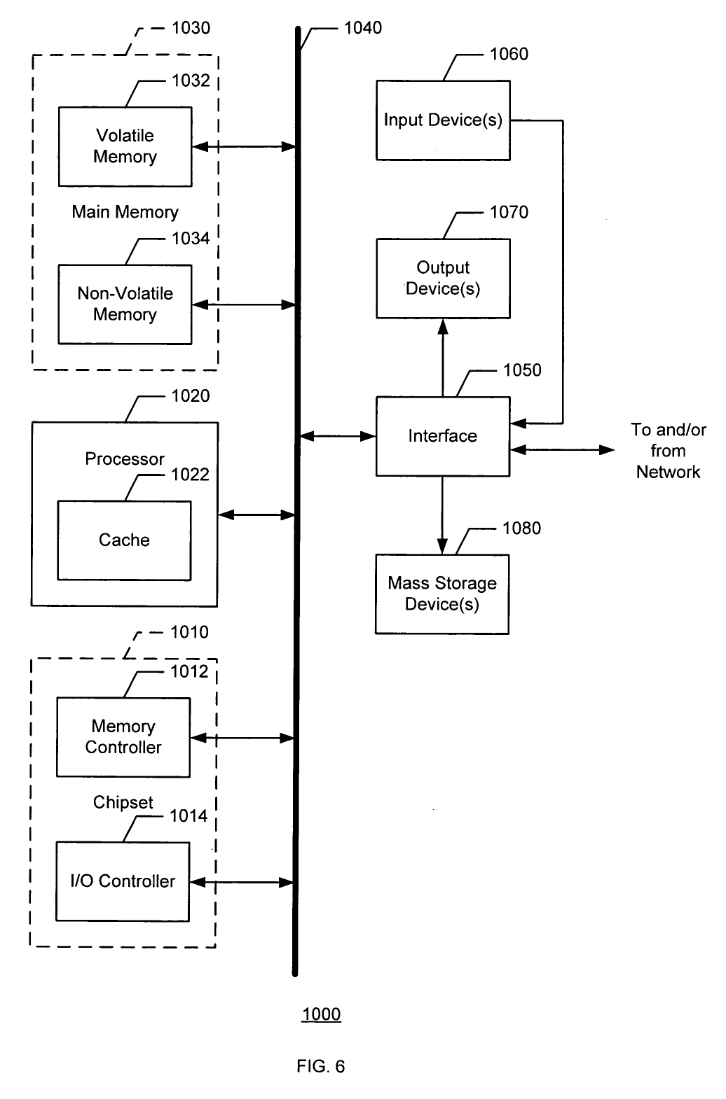

Each of the probes 220 is configured to generate a time stamp representative of the time at which a particular program or application state is first identified at the location in the code of the application 210 where that particular probe 220 is inserted. For example, the time stamp may be generated by a processor (e.g., the processor 1020 of FIG. 6) based on a hardware timer. The time stamp may also be generated by an application program interface (API) specified by an operating system (OS). In another example, the time stamp may be generated by using a shared global variable across all threads of the application to simulate a virtual timer. The shared global variable is initialized to zero and dynamically incremented by one when the probe 220 is executed. Accordingly, the code coverage device 120 generates an instrumented code of the application 230 (i.e., the code of the application 210 including the probes 220).

The debugging and testing device 130 includes a plurality of tests 240, generally shown as 132, 134, 136, and 138. Persons of ordinary skill in the art will appreciate that the plurality of tests 240 may be used to debug the code of the application 210. The debugging and testing device 130 is configured to run the instrumented code of the application 230 and to use the plurality of tests 240 to generate one or more test profiles 250. Each of the test profiles 250 corresponds to one of the plurality of tests 240. For example, the debugging and testing device 130 may generate a test profile corresponding to each of Test 1 (block 132), Test 2 (block 134), Test 3 (block 136), and/or Test n (block 138). In particular, each of the test profiles 250 includes information associated with the corresponding test (i.e., one of the plurality of tests 240). In particular, each of the test profiles 250 may include a time stamp generated by one of the probes 220 as described above. For example, the time stamp may correspond to the first time a particular program state is identified.

The test coverage database 140 is configured to store the test profiles 250 associated with the plurality of tests 240. The test coverage database 140 may be stored in a memory device such as a volatile memory device, a non-volatile memory device, and/or a mass storage device. The data analyzing device 150 is configured to access and process the test profiles 250 stored in the test coverage database 140. In particular, the data analyzing device 150 may organize the test profiles 250 so that the plurality of tests 240 may be identified as described in detail below.

The test identifying device 160 is configured to identify one or more of the plurality of tests 240. In particular, a test selecting device 170 identifies at least one of the plurality of tests 240 based on the analysis of the test profiles 250 by the data analyzing device 150 in response to queries 260 regarding the application made by the user via a user input device 190 (e.g., a keyboard, a mouse, a voice recognition system, etc.). For example, a user (e.g., a software developer and/or a programmer) may inquire about which one of the plurality of tests 240 most quickly reaches a breakpoint in the code of the application 210. Accordingly, a test prioritizing device 180 is configured to generate a prioritized list of tests 270 based on the at least one of the plurality of tests 240 identified by the test selecting device 170. In this manner, the debugging and testing time of the application is minimized by selecting an appropriate group of tests from the plurality of tests 240 to execute on the application rather than executing all of the plurality of tests 240.

While the components shown in FIG. 1 are depicted as separate blocks within the application debugging and testing time minimizing system 100, the functions performed by some or all of these blocks may be integrated within a single semiconductor circuit or may be implemented using two or more separate integrated circuits or software components. For example, although the application source 110 and the code coverage device 120 are depicted as separate blocks, persons of ordinary skill in the art will readily appreciate that the application source 110 and the code coverage device 120 may be integrated into a single block. In another example, although the test selecting device 170 and the test prioritizing device 180 are depicted as separate blocks within the test identifying device 160, persons of ordinary skill in the art will readily appreciate that the test selecting device 170 and the test prioritizing device 180 may be integrated into a single block or structure.

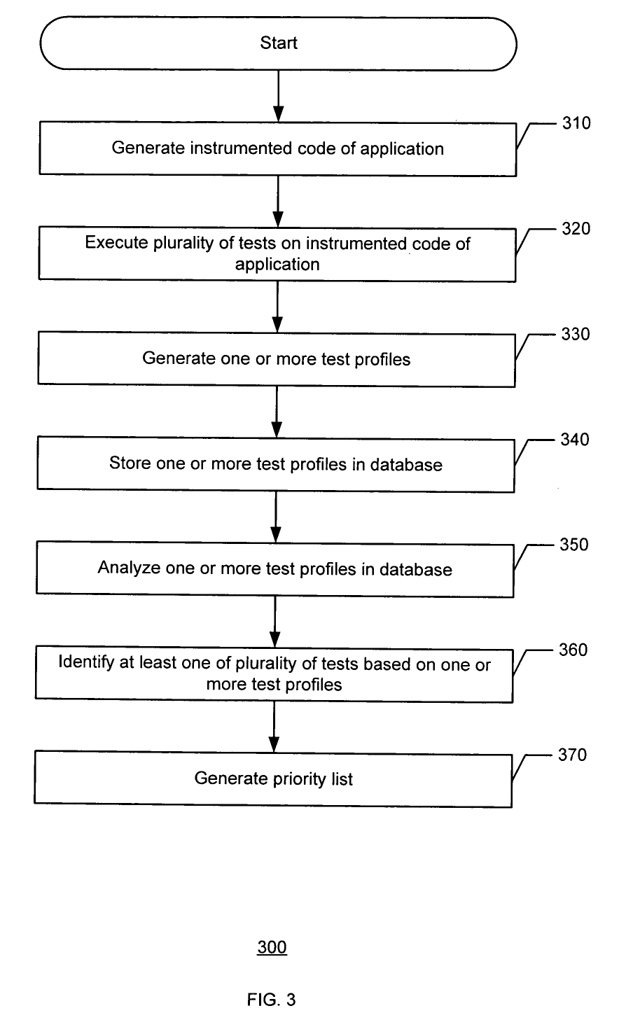

A flow diagram 300 representing one manner in which the application debugging and testing time minimizing system 100 of FIG. 1 may be configured to minimize debugging and testing time of applications is illustrated in FIG. 3. Persons of ordinary skill in the art will appreciate that the flow diagram 300 of FIG. 3 may be implemented using machine readable instructions that are executed by a processor. In particular, the instructions may be implemented in any of many different ways utilizing any of many different programming codes stored on any of many computer-readable mediums such as a volatile or nonvolatile memory or other mass storage device (e.g., a floppy disk, a CD, and a DVD). For example, the machine readable instructions may be embodied in a machine-readable medium such as an erasable programmable read only memory (EPROM), a read only memory (ROM), a random access memory (RAM), a magnetic media, an optical media, and/or any other suitable type of medium. Alternatively, the machine readable instructions may be embodied in a programmable gate array and/or an application specific integrated circuit (ASIC). Further, although a particular order of actions is illustrated in FIG. 3, persons of ordinary skill in the art will appreciate that these actions can be performed in other temporal sequences. Again, the flow diagram 300 is merely provided as an example of one way to minimize debugging and testing time of applications.

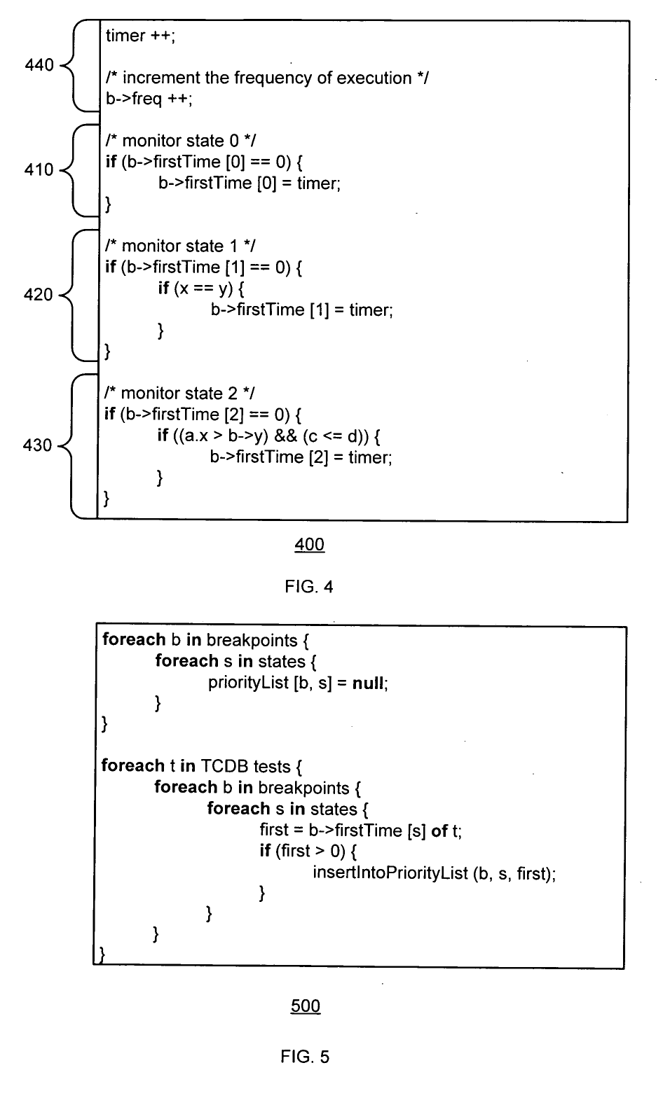

The flow diagram 300 begins with the code coverage device 120 generating the instrumented code of the application 230 from the code of the application 210 (block 310). In particular, the code coverage device 120 inserts one or more probes 220 into the code of the application 210 to generate the instrumented code of the application 230. The debugging and testing device 130 executes a plurality of tests 240 on the instrumented code of the application 230 (block 220). When the plurality of tests 240 is executed, the probes 220 in the instrumented code of the application 230 are configured to identify one or more program states of the application. In the example of FIG. 4, the illustrated probe 400 is configured to identify program states of interest such as a particular logical state (e.g., x=y, a true condition, etc.), generally shown as 410, 420, and 430. Further, the probe 400 (e.g., via a timer 440) is configured to generate one or more time stamps corresponding to each of the one or more program states. The time stamps are based on a timer 440, which may be a hardware timer, a software timer, and/or a virtual timer.

Referring back to FIG. 3, the debugging and testing device 130 generates one or more test profiles 250 associated with the plurality of tests 240 (block 330). Each of the test profiles 250 includes test information of at least one of the plurality of tests 240. For example, each of the test profiles 250 may include at least one time stamp corresponding to one or more program states of the application.

The debugging and testing device 130 stores the one or more test profiles 250 in the test coverage database 140 (block 340), and the data analyzing device 150 may access the test coverage database 140 to analyze the one or more test profiles 250 (block 350). In particular, the data analyzing device 150 may identify a particular time stamp indicating the earliest time at which the program state is reached in the application. For example, the data analyzing device 150 may be implemented by the code shown in FIG. 5. Thus, that particular time stamp may indicate the first time that particular program state is identified when the application is executed.

Based on the one or more test profiles 250 in the test coverage database 140, the test identifying device 160 (via the test selecting device 170) identifies at least one of the plurality of tests to test the application (block 360). In response to a user query via the user input device 190, the test selecting device 170 may identify at least one of the plurality of tests 240 based on the test profiles 250. For example, a user may inquire about which one of the plurality tests 240 causes the application to most quickly reach a particular breakpoint in a particular situation. Alternatively, the debug query by the user may be pre-programmed. Accordingly, the test prioritizing device 180 generates a prioritized list of tests from the at least one of the plurality of tests 240 identified by the test selecting device 170 to minimize the total amount of time to test the application (block 370). As a result, development cost of the application may be reduced because it is not necessary to run all of the plurality of tests 240 to test the code of the application 210.

FIG. 6 is a block diagram of an example processor system 1000 adapted to implement the methods and apparatus disclosed herein. The processor system 1000 may be a desktop computer, a laptop computer, a notebook computer, a personal digital assistant (PDA), a server, an Internet appliance or any other type of computing device.

The processor system 1000 illustrated in FIG. 6 includes a chipset 1010, which includes a memory controller 1012 and an input/output (I/O) controller 1014. As is well known, a chipset typically provides memory and I/O management functions, as well as a plurality of general purpose and/or special purpose registers, timers, etc. that are accessible or used by a processor 1020. The processor 1020 is implemented using one or more processors. For example, the processor 1020 may be implemented using one or more of the Intel® Pentium® family of microprocessors, the Intel® Itanium® family of microprocessors, Intel® Centrino® family of microprocessors, and/or the Intel XScale® family of processors. In the alternative, other processors or families of processors may be used to implement the processor 1020. The processor 1020 includes a cache 1022, which may be implemented using a first-level unified cache (L1), a second-level unified cache (L2), a third-level unified cache (L3), and/or any other suitable structures to store data as persons of ordinary skill in the art will readily recognize.

As is conventional, the memory controller 1012 performs functions that enable the processor 1020 to access and communicate with a main memory 1030 including a volatile memory 1032 and a non-volatile memory 1034 via a bus 1040. The volatile memory 1032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 1034 may be implemented using flash memory, Read Only Memory (ROM), Electrically Erasable Programmable Read Only Memory (EEPROM), and/or any other desired type of memory device.

The processor system 1000 also includes an interface circuit 1050 that is coupled to the bus 1040. The interface circuit 1050 may be implemented using any type of well known interface standard such as an Ethernet interface, a universal serial bus (USB), a third generation input/output interface (3GIO) interface, and/or any other suitable type of interface.

One or more input devices 1060 are connected to the interface circuit 1050. The input device(s) 1060 permit a user to enter data and commands into the processor 1020. For example, the input device(s) 1060 may be implemented by a keyboard, a mouse, a touch-sensitive display, a track pad, a track ball, an isopoint, and/or a voice recognition system.

One or more output devices 1070 are also connected to the interface circuit 1050. For example, the output device(s) 1070 may be implemented by display devices (e.g., a light emitting display (LED), a liquid crystal display (LCD), a cathode ray tube (CRT) display, a printer and/or speakers). The interface circuit 1050, thus, typically includes, among other things, a graphics driver card.

The processor system 1000 also includes one or more mass storage devices 1080 configured to store software and data. Examples of such mass storage device(s) 1080 include floppy disks and drives, hard disk drives, compact disks and drives, and digital versatile disks (DVD) and drives.

The interface circuit 1050 also includes a communication device such as a modem or a network interface card to facilitate exchange of data with external computers via a network. The communication link between the processor system 1000 and the network may be any type of network connection such as an Ethernet connection, a digital subscriber line (DSL), a telephone line, a cellular telephone system, a coaxial cable, etc.

Access to the input device(s) 1060, the output device(s) 1070, the mass storage device(s) 1080 and/or the network is typically controlled by the I/O controller 1014 in a conventional manner. In particular, the I/O controller 1014 performs functions that enable the processor 1020 to communicate with the input device(s) 1060, the output device(s) 1070, the mass storage device(s) 1080 and/or the network via the bus 1040 and the interface circuit 1050.

While the components shown in FIG. 6 are depicted as separate blocks within the processor system 1000, the functions performed by some of these blocks may be integrated within a single semiconductor circuit or may be implemented using two or more separate integrated circuits. For example, although the memory controller 1012 and the I/O controller 1014 are depicted as separate blocks within the chipset 1010, persons of ordinary skill in the art will readily appreciate that the memory controller 1012 and the I/O controller 1014 may be integrated within a single semiconductor circuit.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method comprising:
generating an instrumented code of the application;
executing a plurality of tests on the instrumented code of the application;
generating one or more test profiles associated with the plurality of tests; and
identifying at least one of the plurality of tests based on the one or more test profiles.

2. A method as defined in claim 1, wherein generating the instrumented code of the application comprises inserting one or more probes into the application.

3. A method as defined in claim 1, wherein generating the one or more test profiles associated with the plurality of tests comprises identifying one or more program states of the application and generating one or more time stamps corresponding to each of the one or more program states.

4. A method as defined in claim 1, wherein generating the one or more test profiles associated with the plurality of tests comprises generating one or more time stamps indicative of an earliest time corresponding to a breakpoint of the application associated with one or more program states.

5. A method as defined in claim 1, wherein generating the one or more test profiles associated with the plurality of tests comprises generating one or more time stamps corresponding to one or more program states of the application based on at least one of a hardware timer, a software timer, and a virtual timer.

6. A method as defined in claim 1, wherein identifying the at least one of the plurality of tests based on the one or more test profiles comprises generating a priority list having the at least one of the plurality of tests to identify one or more breakpoints of the application associated with one or more program states.

7. A method as defined in claim 1, wherein identifying the at least one of the plurality of tests based on the one or more test profiles comprises identifying the at least one of the plurality of tests based on the one or more test profiles in response to a query.

8. A method as defined in claim 1 further comprising storing the one or more test profiles in a database.

9. A machine readable medium storing instructions that, when executed, cause a machine to:
generate an instrumented code of the application;
execute a plurality of tests on the instrumented code of the application;
generate one or more test profiles associated with the plurality of tests; and
identify at least one of the plurality of tests based on the one or more test profiles.

10. A machine readable medium as defined in claim 9, wherein the instructions, when executed, cause the machine to generate the instrumented code of the application by inserting one or more probes into the application.

11. A machine readable medium as defined in claim 9, wherein the instructions, when executed, cause the machine to generate the one or more test profiles associated with the plurality of tests by identifying one or more program states of the application and generating one or more time stamps corresponding to each of the one or more program states.

12. A machine readable medium as defined in claim 9, wherein the instructions, when executed, cause the machine to generate the one or more test profiles associated with the plurality of tests by generating one or more time stamps indicative of an earliest time corresponding to a breakpoint of the application associated with one or more program states.

13. A machine readable medium as defined in claim 9, wherein the instructions, when executed, cause the machine to generate the one or more test profiles associated with the plurality of tests by generating one or more time stamps corresponding to one or more program states of the application based on at least one of a hardware timer, a software timer, and a virtual timer.

14. A machine readable medium as defined in claim 9, wherein the instructions, when executed, cause the machine to identify the at least one of the plurality of tests based on the one or more test profiles by generating a priority list having the at least one of the plurality of tests to identify one or more breakpoints of the application associated with one or more program states.

15. A machine readable medium as defined in claim 9, wherein the instructions, when executed, cause the machine to identify the at least one of the plurality of tests based on the one or more test profiles and user input by generating a priority list having at least one of the plurality of tests to identify the one or more program states for each breakpoint of the application.

16. A machine readable medium as defined in claim 9, wherein the instructions, when executed, cause the machine to identify the at least one of the plurality of tests based on the one or more test profiles comprises identifying at least one of the plurality of tests based on the one or more test profiles in response to a query.

17. A machine readable medium as defined in claim 9, wherein the instructions, when executed, cause the machine to store the one or more test profiles in a database.

18. A machine readable medium as defined in claim 9, wherein the machine readable medium comprises at least one of a programmable gate array, application specific integrated circuit, erasable programmable read only memory, read only memory, random access memory, magnetic media, and optical media.

19. An apparatus comprising:
a data structure configured to store one or more test profiles;
a code coverage device configured to generate an instrumented code of the application;
a debugging and testing device configured to execute a plurality of tests on the instrumented code of the application, and to generate one or more test profiles associated with the plurality of tests; and
a test identifying device configured to identify at least one of the plurality of tests based on the one or more test profiles.

20. An apparatus as defined in claim 19, wherein the code coverage device comprises at least one of a compiler, an assembler, an interpreter, and a post-link optimizer.

21. An apparatus as defined in claim 19, wherein the instrumented code of the application comprises one or more probes to identify one or more program states of the application and to generate one or more time stamps corresponding to each of the one or more program states.

22. An apparatus as defined in claim 19, wherein the one or more test profiles comprises one or more time stamps indicative of an earliest time corresponding to a breakpoint of the application associated with one or more program states of the application.

23. An apparatus as defined in claim 19, wherein the test identifying device is configured to identify at least one of the plurality of tests based on the one or more test profiles in response to a query.

24. An apparatus as defined in claim 19, further comprising a test prioritizing device configured to generate a priority list having at least one of the plurality of tests.

25. A processor system comprising:
a dynamic random access memory (DRAM) configured to store at least one test and;
a processor operatively coupled to the DRAM, the processor being configured to:
generate an instrumented code of the application;
execute a plurality of tests on the instrumented code of the application;
generate one or more test profiles associated with the plurality of tests; and
identify at least one of the plurality of tests based on the one or more test profiles.

26. A processor system as defined in claim 25, wherein the instrumented code of the application comprises one or more probes inserted into the application to identify one or more program states of the application and to generate one or more time stamps corresponding to each of the one or more program states.

27. A processor system as defined in claim 25, wherein the one or more test profiles comprises one or more time stamps corresponding to one or more program states of the application.

28. A processor system as defined in claim 25, wherein the one or more test profiles comprises one or more time stamps indicative of an earliest time corresponding to a breakpoint of the application associated with one or more program states of the application.

29. A processor system as defined in claim 25, wherein the processor is configured to generate a priority list having the at least one of the plurality of tests to identify one or more breakpoints of the application associated with one or more program states.

30. A processor system as defined in claim 25, wherein the processor is configured to identify the at least one of the plurality of tests based on the one or more test profiles in response to a query.
